(19) United States
(12) Patent Application Publication
(10) Pub. No.: US 2008/0079958 A1
(43) Pub. Date: Apr. 3, 2008

(54) Printing apparatus

(75) Inventor: Akiko Niimi, Kasugai (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya (JP)

(21) Appl. No.: 11/902,443

(22) Filed: Sep. 21, 2007

(30) Foreign Application Priority Data
Sep. 28, 2006 (JP) 2006-266080

(51) Int. Cl. G06F 3/12

(52) U.S. Cl. 358/1.1

(57) ABSTRACT

A printing apparatus is provided with a medium supporting unit configured to support a recording medium, a first recording head, a second recording head, a first head moving device configured to move the first recording head, a second head moving device configured to move the second recording head, in the main scanning direction. The medium supporting unit is controlled to move such that a moving range of the medium supporting unit is differentiated depending on whether the ink is ejected from both the first recording head and the second recording head, only from the first recording head or only from the second recording bead.

### CROSS-REFERENCE TO RELATED APPLICATION

This application claims priority from Japanese Patent Application No. 2006-266080, filed on Sep. 28, 2006, the entire subject matter of which is incorporated herein by reference.

### BACKGROUND

1. Field of the Invention

The present invention relates to a printing apparatus. Specifically, the present invention relates to a moving control of a medium supporting unit of a printing apparatus having a plurality of recording heads.

2. Related Art

Conventionally, in a printing apparatus capable of ejecting a plurality of colors of inks (including black or white ink) from recording heads on a recording medium, the recording heads ejecting plurality of colors of inks are arranged side by side in a main scanning direction, and moved in the main scanning direction for printing. In such printing apparatus, the recording heads are driven individually by applying head driving signals from a control circuit, so that the inks are ejected. Therefore, when an image is printed with color inks, firstly a deep colored background of the recording medium is masked with a white ink, and then, a color image is formed thereon. Specifically, the recording medium is set on the medium supporting unit, which is movable in an auxiliary scanning direction, and the medium supporting unit is located at a print start position. Then, firstly, only the white ink is ejected from a recording head of the white ink for masking with all the recording heads being moved in the main scanning direction, and the medium supporting unit being moved in the auxiliary scanning direction. Thereafter, the medium supporting unit is moved back to the print start position, and the color inks are ejected to form a color image with the recording heads being moved in the main scanning direction and the medium supporting unit being moved in the auxiliary scanning direction. An example of such a configuration is disclosed in Japanese Patent Provisional Publication No. P2005-161583A (hereinafter, referred to as '583 publication).

Incidentally, there is known an inkjet recording apparatus provided with a first carriage mounting a first inkjet recording head on an upstream side, in a feeding direction (i.e., the auxiliary scanning direction) of the recording medium, and a second carriage mounting a second inkjet recording head on a downstream side in the auxiliary scanning direction. An example of such a configuration is disclosed in Japanese Patent Publication No. 3029516 (hereinafter, referred to as '516 patent). According to '516 publication, the inkjet recording apparatus has a hot-air duct provided between the first carriage and the second carriage to dry the ink ejected by the first inkjet recording head so that printing with the second inkjet recording head can be done on a dried ink on the recording medium.

However, since the printing apparatus according to '583 publication has the inkjet recording head for the white ink and the inkjet recording heads for other colors in a single carriage, the white ink is firstly printed to complete the main scanning and auxiliary scanning operations, and then the color image is formed with other colors with the main and auxiliary scanning operations are performed again. Therefore, according to such a configuration, a time for printing the color image after masking the background with white ink, a period necessary for printing becomes more than twice in comparison with a case where the making is not done. If it is necessary to wait until the white ink (i.e., the masking) is dried, more time is required. Further, since the recording heads which are not driven should also be moved, a problem may arise such that a surface of the recording head which is not driven becomes dried and/or foreign substances are adhered onto the surface of the recording head

According to '516 patent, the recording medium is wound around a fabric feeding portion, fed therefrom to pass in front of the first and second inkjet recording heads, and then wound by a take-up portion. Therefore, a printing image which is wider than a distance between the first inkjet recording head and the second inkjet recording head cannot be printed.

### SUMMARY OF THE INVENTION

The present invention is advantageous in that an improved printing apparatus is provided, which has a plurality of recording heads arranged to move (scan) in parallel. In the printing device, a moving time of a medium supporting unit is reduced so that a printing time is shortened by optimizing a moving range of the medium supporting unit

According to an aspect of the invention, there is provided a printing apparatus, which is provided with a medium supporting unit having a supporting surface configured to support a recording medium, a first recording head configured to eject ink in accordance with a print data, a second recording head configured to eject ink in accordance with the print data. Further, the printing apparatus includes a recording head control device configured to control the first recording head and the second recording head. Further provided are a first head moving device configured to move the first recording head, in a main scanning direction, relatively to the medium supporting unit, a second head moving device configured to move the second recording head, in the main scanning direction, relatively to the medium supporting unit, and a head movement control device configured to control the first head moving device and the second head moving device. The printing apparatus is also provided with a medium supporting unit moving device configured to move the medium supporting unit, and a medium movement control device configured to control the medium supporting unit moving device to move the medium supporting unit such that a moving range of the medium supporting unit is differentiated depending on whether the ink is ejected from both the first recording head and the second recording head, only from the first recording head or only from the second recording head

According to the above configuration, the moving range of the medium supporting unit is optimized depending on the recording head(s) to be driven, thereby reducing a time for moving the medium supporting unit and for printing.

According to another aspect, there is provided a method of controlling a printing apparatus which is provided with a medium supporting unit configured to support a recording medium, a first recording head configured to eject ink in accordance with a print data, a second recording head configured to eject ink in accordance with the print data. The method includes the steps of (a) moving the medium supporting unit is moved within a first moving range in an auxiliary scanning direction which is perpendicular to the main scanning direction when the ink is ejected from both the first recording head and the second recording head, the first moving range of the medium supporting unit being a moving range relative to the first head moving device and the second head moving device, (b) moving the medium supporting unit within a second moving range in the auxiliary scanning direction when the ink is ejected only from the first recording head, the second moving range of the medium supporting unit being a moving range relative to the first head moving device, and (c) moving the medium supporting unit within a third moving range in the auxiliary scanning direction when the ink is ejected only from the second recording head, the third moving range of the medium supporting unit being a moving range relative to the second head moving device, and the first moving range, second moving range and third moving range are different from each other.

According to a further aspect, there is provided a recoding medium storing a computer program which causes a computer, when executed thereby, to control a printing apparatus which is provided with a medium supporting unit configured to support a recording medium, a first recording head configured to eject ink in accordance with a print data, a second recording head configured to eject ink in accordance with the print data. The program includes the instructions to (a) move the medium supporting unit is moved within a first moving range in an auxiliary scanning direction which is perpendicular to the main scanning direction when the ink is ejected from both the first recording head and the second recording head, the first moving range of the medium supporting unit being a moving range relative to the first head moving device and the second head moving device, (b) move the medium supporting unit within a second moving range in the auxiliary scanning direction when the ink is ejected only from the first recording head, the second moving range of the medium supporting unit being a moving range relative to the first head moving device, and (c) move the medium supporting unit within a third moving range in the auxiliary scanning direction when the ink is ejected only from the second recording head, the third moving range of the medium supporting unit being a moving range relative to the second head moving device, the first moving range, second moving range and third moving range being different from each other.

### BRIEF DESCRIPTION OF THE ACCOMPANYING DRAWINGS

FIG. 1 is a plan view of an inkjet printer according to the present invention.

FIG. 2 is front view of the inkjet printer shown in FIG. 1.

FIG. 3 is a block diagram showing an electrical configuration of the inkjet printer according to the invention.

FIG. 4 is a plan view schematically showing a structure of a feeding system of a platen of the inkjet printer according to the invention.

FIG. 5 is a right side view schematically showing the structure of the feeding system shown in FIG. 4.

FIG. 6 is block diagram showing a control configuration of a stepper motor employed in the inkjet printer shown in FIG. 1.

FIG. 7 is a plan view showing a print medium loading position of the platen.

FIG. 8 is a plan view showing a print start position of the platen.

FIG. 9 is a plan view showing a print end position of the platen.

FIG. 10 is a plan view showing a print end position of the platen.

FIG. 11 is a plan view showing a print start position of the platen.

FIG. 12 is a plan view showing a print end position of the platen.

FIG. 13 is a plan view showing a modified example of a main cover of the inkjet printer.

FIG. 14 is a flowchart showing print data generating process in which print data to be printed by the inkjet printer is generated.

FIG. 15 is flowchart showing a print process performed by the inkjet printer.

### DETAILED DESCRIPTION OF THE EMBODIMENT

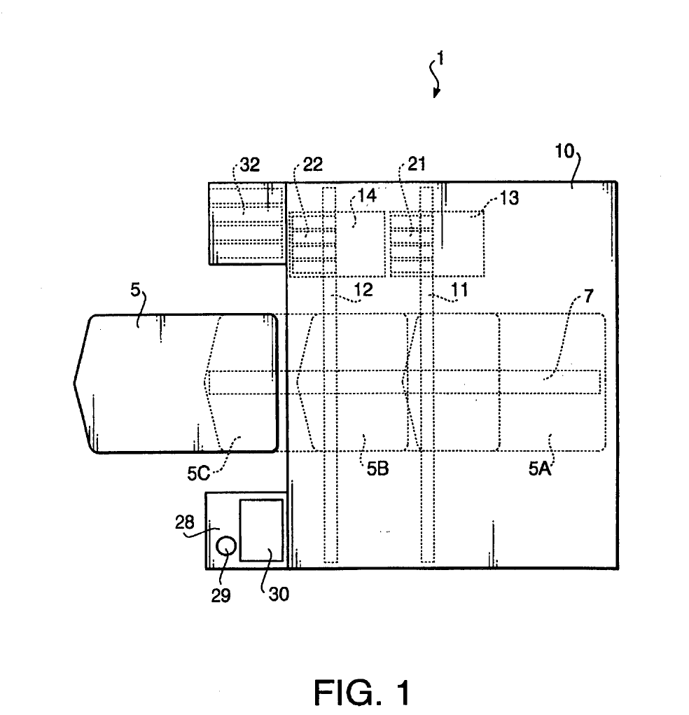

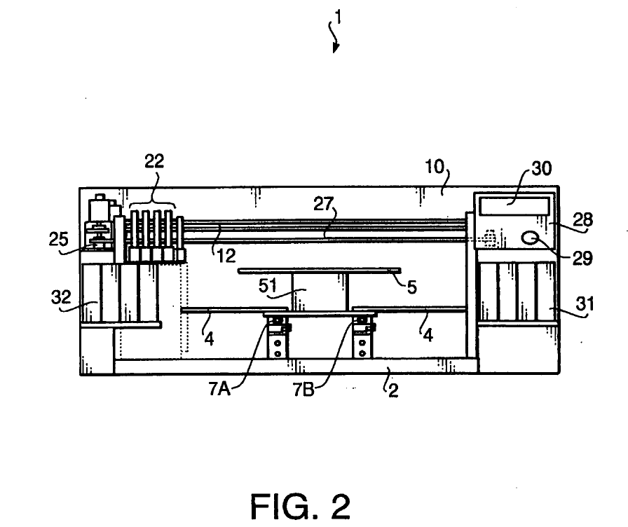

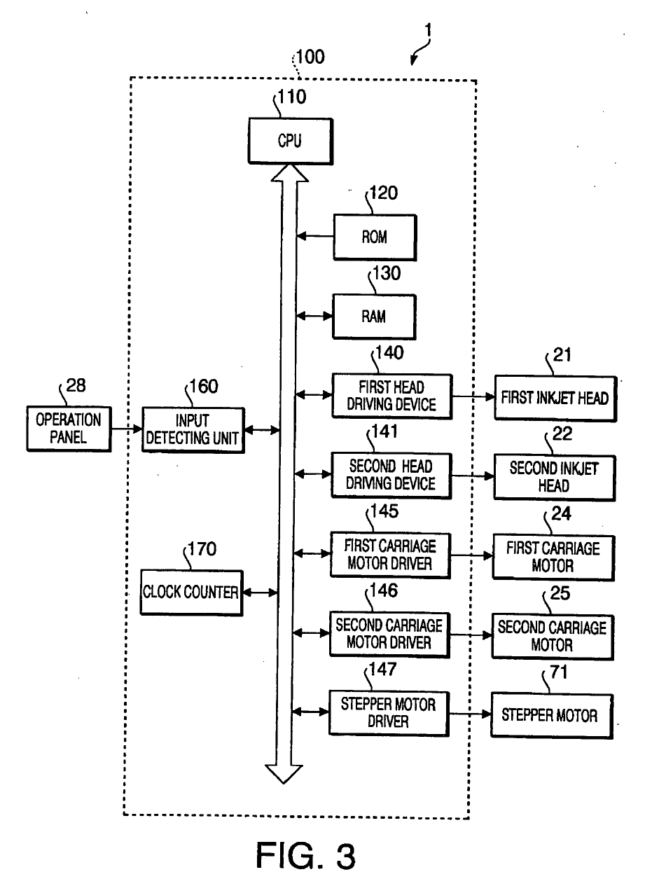

Referring to the drawings, an illustrative embodiment in accordance with the present invention will be described. Firstly, referring to FIGS. 1-3, An inkjet printer 1 according to the present embodiment will be described. FIG. 1 is a plan view of an inkjet printer 1, FIG. 2 is a front view of the inkjet printer 1, and FIG. 3 is a block diagram showing an electrical configuration of the inkjet printer 1.

In the present embodiment, the inkjet printer 1 is of a well-known inkjet printer, which is capable of printing images on a recording medium by supplying ink to a first inkjet head 21 and a second inkjet head 22, each having a nozzle face for ejecting the ink. The inkjet printer 1 is capable of printing on a fabric such as a T-shirt as the recording medium, based on the input image information, etc. As shown in FIGS. 1 and 2, the inkjet printer 1 is provided with a base 2 having a planar plate shape on the bottom surface, and a main cover 10 covering the entire apparatus.

A recording system in the main cover 10 is of a well-known inkjet type recording system. In the inkjet printer 1, a guide rail 11 for guiding a movement of a carriage 13 loading the first inkjet head 21, is provided to extend in a horizontal direction of the inkjet printer 1 (i.e., an up-and-down direction in FIG. 1, which is a left-and-right direction of the inkjet printer 1). A carriage belt is provided between a first carriage motor 24 (see FIG. 3) placed in the vicinity of a left edge of the guide rail 11 (i.e., in the vicinity of an upper side in FIG. 1) and a pulley placed in the vicinity of a right edge of the guide rail 11 (i.e., in the vicinity of a lower side in FIG. 1). The carriage belt is fixed on a rear surface of the carriage 13 so that the carriage 13 can be reciprocated along the guide rail 11 by driving of the first carriage motor 24 to move the carriage belt. The guide rail 11 is adapted to an adapting portion which is also formed on the rear surface of the carriage 13. Incidentally, a first maintenance system (which includes a capping system, a wiping system and a purging system (not shown)) for maintenance of the first inkjet head 21 is provided on the right end or the left end of the guide rail 11.

Additionally, a guide rail 12 for guiding a movement of a carriage 14 loading the second inkjet head 22, is provided in parallel to the guide rail 11 in the inkjet printer 1. A carriage belt is provided between a second carriage motor 25 (see FIG. 3) placed in the vicinity of a left edge of the guide rail 12 (i.e., in the vicinity of the upper side in FIG. 1) and a pulley placed in the vicinity of a right edge of the guide rail 12 (i.e., in the vicinity of the lower side in FIG. 1). The carriage belt is fixed on a rear surface of the carriage 14 so that the carriage 14 can be reciprocated along with the guide rail 12 by driving the second carriage motor 25 to move the carriage belt The guide rail 12 is adapted to an adapting portion placed on the rear surface of the carriage 14. Incidentally, a second maintenance system (which includes a capping system, a wiping system and a purging system (not shown)) for maintenance of the second inkjet head 21 is provided on the right end or the left end of the guide rail 12.

It is noted that in the present embodiment, a left-hand side of FIG. 1 corresponds to a front side of the inkjet printer 1 and an upper side and lower side of FIG. 1 and a left-hand side and a right-hand side of FIG. 2 correspond to a left side and a right side of the inkjet printer 1, respectively. Additionally, the first inkjet head 21 and second inkjet head 22 are configured to scan in the horizontal direction (which will also be referred to as a main scanning direction) in the inkjet printer 1 (i.e., the up-and-down direction in FIG. 1). Incidentally, the distance between the guide rail 11 and the guide rail 12 can be narrowed unless the carriage 13 and the carriage 14 are contacted or interfered with each other. The distance between the guide rail 11 and 12 may be widened, however, in such a case, the size of the main cover needs to be increased.

Additionally, a feeding system 7 capable of guiding a movement of a platen 5 for supporting a recording medium, in an anteroposterior direction in the inkjet printer 1 (i.e., the right-and-left direction in FIG. 1), is provided on a base 2. As shown FIG. 2, the feeding system 7 includes guide rails 7A and 7B and a stepper motor 71 (see FIGS. 3 to 6) fixed on a rear end portion (i.e., a right-hand side end portion in FIG. 1) of the guide rails 7A and 7B. The platen 5 is reciprocated along the guide rails 7A and 7B of the feeding system 7 by driving the stepper motor 71 as indicated in 5C, 5B and SA in FIG. 1. The stepper motor 7 is protected by a motor cover (not shown) placed at the rear side in the main cover 10 (i.e., the right-hand side in FIG. 1).

The platen 5 has a pentagonal shape in a plan view. Specifically, the platen 5 has a shape of pentagonal plate having a projecting angle facing to a user, and a fabric recording medium (e.g., T-shirt, etc.) can be loaded horizontally on an upper surface of the platen 5. It is noted that the platen 5 according to the embodiment is an only an example and may have various types of shape, and the shape of the platen 5 to be used is determined in accordance with the recording medium, such as the size of a T-shirt, etc.

Additionally, as shown in FIG. 2, a tray 4 is provided on the lower side of the platen 5. The tray 4 has a bottom surface in parallel to the top surface of the platen 5, and its periphery is slightly larger than that of the platen 5 in a plan view. The tray 4 is configured to catch the sleeves or the like of the T-shirt so that they do not drop on the base 2 when the user put the T-shirt on the platen 5.

As shown in FIG. 2, an ink cartridge housing unit 32 housing an ink cartridge of a white ink is provided on the left edge of the front side of the main cover 10. The ink cartridge in the ink cartridge housing unit 32 has a supplying tube for a white ink. The supplying tube for the white ink is connected to the first inkjet head 21 to supply the white ink to the first inkjet head 21. As shown in FIGS. 1 and 2, an operation panel 28 for operating the inkjet printer 1 is provided on the right end portion of the front side of the main cover 10. The operation panel 28 is provided with a displaying unit 30 including a print button 29 to instruct printing and an LCD to display various information. Additionally, an ink cartridge housing unit 31 housing ink cartridges of each of CMYK (Cyan, Magenta, Yellow and Black) inks is provided on the lower side of the operation panel 28. The ink cartridge in the ink cartridge housing unit 31 has supplying tubes for each color ink. The supplying tubes for the color ink are connected to the second inkjet head 22 to supply CMYK inks to the second inkjet head 21. It is noted that the first inkjet head 21 is an inkjet head ejecting only a white ink and the second inkjet head 22 is an inkjet head ejecting Cyan (C), Magenta (M), Yellow (Y) and Black (B) inks.

Next, an electrical configuration of the inkjet printer 1 will be described referring to FIG. 3. As shown in FIG. 3, a control device 100 of the inkjet printer 1 is provided with a CPU 110 which conducts an entire control of the inkjet printer 1. The CPU 110 is connected to a ROM 120 for storing various control programs to be executed by the CPU 110 and a RAM 130 for storing data temporarily through a bus 115. Further, the CPU 110 is connected to a first head driving device 140 for driving a piezoelectric actuator provided on each channel of the first inkjet head 21, a second head driving device 141 for driving a piezoelectric actuator provided on each channel of the second inkjet head 22, a first carriage motor driver 145 for driving the first carriage motor 24, a second carriage motor driver 146 for driving the second carriage motor 25, a stepper motor driver for driving the stepper motor 71, a clock counter 170 for generating a timing signal to measure a timing for control of the CPU 110 and an input detecting unit 160 connected to the operation panel 28 and sensors (not shown), respectively, through the bus 115.

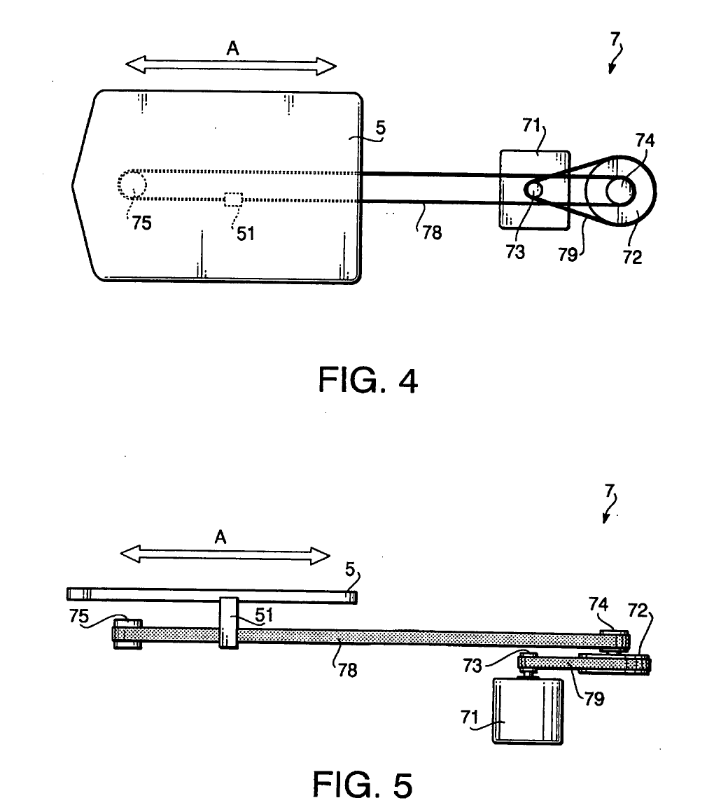

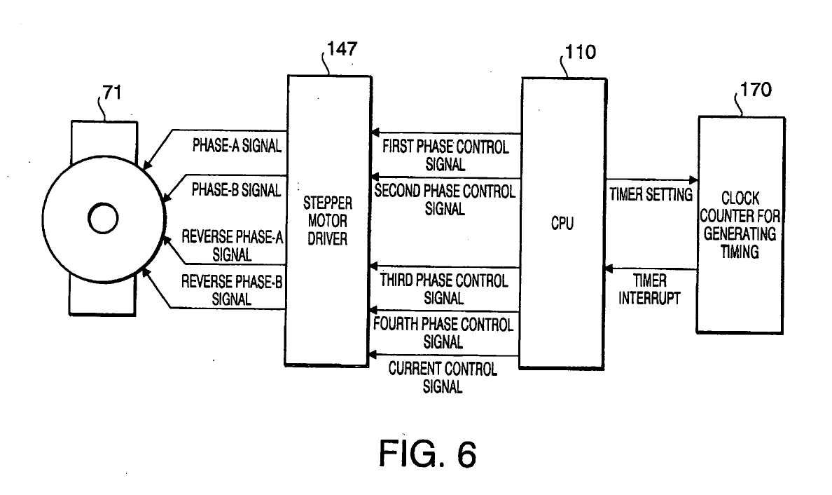

Hereinafter, a feeding system 7 of the platen 5 in the inkjet printer 1 will be described referring to FIGS. 4 to 6. FIG. 4 is a plan view schematically showing a feeding system of the platen 5, FIG. 5 is a right side view schematically showing a structure of the feeding system of the platen 5 and FIG. 6 is a block diagram showing a control of the stepper motor 71 of the inkjet printer 1. It is noted that the left-hand side and right-hand side in FIG. 4 and FIG. 5 correspond to the front side and rear side of the inkjet printer 1, respectively.

As sown in FIG. 4 and FIG. 5, a motor pulley 73 is secured to a shaft of the stepper motor 71 and rotates with a rotation of the stepper motor 71, and a motor belt 79 is wound around the motor pulley and a large pulley 72 so that the large pulley 72 is rotated by the rotation of the motor pulley which is rotated when the stepper motor 71 is driven. Additionally, a first belt pulley 74 having a same axis of rotation as the large pulley 72 is rotated with the rotation of the large pulley 72. The stepper motor 71, the motor pulley 73, the large pulley 72 and the first belt pulley 74 are provided at the rear side part of the inkjet printer 1, specifically, on the lower side of the platen 5 inside the main cover 10. A second belt pulley 75 corresponding to the first belt pulley 74 is provided in the front side of the inkjet printer 1 (i.e., the left-hand side in FIG. 4 and FIG. 5) and a timing belt 78 is wound around the first belt pulley 74 and the second belt pulley 75. It should be noted that a diameter of the second belt pulley 75 is equal to that of the first belt pulley 74.

The timing belt 78 is arranged to be perpendicular to the main scanning direction of the first inkjet head 21 and the second inkjet head 22 (i.e., a direction parallel with the guide rail 11 and 12). Specifically, the timing belt 78 is arranged so that a line connecting the center of the first belt pulley 74 and the center of the second belt pulley 75 is perpendicular to the main scanning direction of the first inkjet head 21 and the second inkjet head 22 (i.e., in a direction parallel with the guide rails 11 and 12). The platen 5 is fixed on the timing belt 78 by a platen mounting device 51 so that the platen 5 is moved in an anteroposterior direction (i.e., the front-and-rear direction) in the inkjet printer 1 (i.e., in a direction indicated by an arrow A in FIG. 4 and FIG. 5) as the timing belt 78 is moved. With the above configuration, the rotation of the stepper motor 71 is converted to the horizontal movement of the platen 5 through the motor pulley 73, the motor belt 79, the large pulley 72, the first belt pulley 74, the timing belt 78 and the second belt pulley 75.

Hereinafter, a configuration of the stepper motor 71 will be described in detail. The stepper motor 71 is a well known 1-2 phase excitation type stepper motor. In the stepper motor 71, a stator to be used as an electrical magnet is arranged around a rotor. When the stator is excited, the rotor is pulled to the electrical magnet (stator), and thereby rotating the rotor by one step. Specifically, the stator may be supplied with one of four excitation phases (i.e., a phase A, a reverse phase A, a phase B and a reverse phase B) and they are arranged in an order of the phase A, the phase B, the reverse phase A, the reverse phase B, the phase A, the phase B and so on, clockwise. The stator is excited in an order of the phase A only, the phase A and the phase B, the phase B only, the phase B and the reverse phase A, the reverse phase A only, the reverse phase A and the reverse phase B, the reverse phase B only, the reverse phase B and the phase A, the phase A only and so on. When the excited phase is magnetized of N (north) pole, the S (south) pole of the rotor is attracted and the north pole of the rotor is repelled, thereby rotating the rotor by one step.

Thus, the stepper motor is rotated by exciting the stator successively, and therefore, the platen 5 is moved horizontally in the anteroposterior direction of the inkjet printer 1. Additionally, an angle of rotation of the rotor at one excitation is determined in accordance with a number of the north poles and the south poles of the rotor. Therefore, the moving distance of the platen 5 can be controlled in accordance with a number of rotation steps of the stepper motor 71.

As shown in FIG. 6, in the control of excitation of the stepper motor 71, during the CPU 110 transmits a first phase control signal to the stepper motor driver 147 (i.e., a status of a pulse signal is high), the stepper motor driver 147 transmits a phase A signal for exciting the phase A to the stepper motor 71, and then the phase A is excited. During the CPU 110 transmits a second phase control signal (i e., a status of a pulse signal is high), the stepper motor driver 147 transmits a phase B signal for exciting the phase B to the stepper motor 71, and then the phase B is excited. Additionally, during the CPU 110 transmits a third phase control signal (i.e., a status of a pulse signal is high), the stepper motor driver 147 transmits a reverse phase A signal for exciting the reverse phase A to the stepper motor 71, and then the reverse phase-A is excited. Further, during the CPU 110 transmits a fourth phase control signal (i.e., a status of a pulse signal is high), the stepper motor driver 147 transmits a reverse phase B signal for exciting the reverse phase-B to the stepper motor 71, and then the reverse phase B is excited.

Therefore, by elongating a switching interval of the phase control signals, the rotation speed of the stepper motor 71 can be made slower, and by shortening the interval the rotation speed of the stepper motor 71 can be made faster. However, when the phase control signal is switched in a short interval at the beginning of the rotation of the stepper motor 71, the rotor might not be rotated since the rotor can not be attracted to the excited phases. Further, when the excitation is suddenly terminated to stop the rotation of the stepper motor 71, the rotor might not be stopped but continue to rotate due to the law of inertia

Therefore, when starting or stopping the rotation of the stepper motor 71 (i.e., moving or stopping the platen 5), the switching interval of the phase control signals should be changed gradually. Specifically, when starting, the rotation speed of the stepper motor 7 is accelerated till it reaches the moving speed by shortening the switching interval of the phase control signals gradually, and when stopping, the rotation speed of the stepper motor 7 is decelerated until the stepper motor 7 is stopped by elongating the switching interval of the phase control signals gradually. Incidentally, the clock counter 170 and an acceleration table (not shown) are used for switching the phase control signals. The acceleration table is stored in the RAM 130 and stores count values representing the timings of switching the phase control signals for an acceleration state (multiple count values for gradually shortening the switching interval), a steady speed (single count value for a constant speed) and a deceleration state (multiple count values for gradually elongating the switching interval). The CPU 110 controls to switch the phase control signals at the timings when the count value of the clock counter 170 reaches the count values read out from the acceleration table.

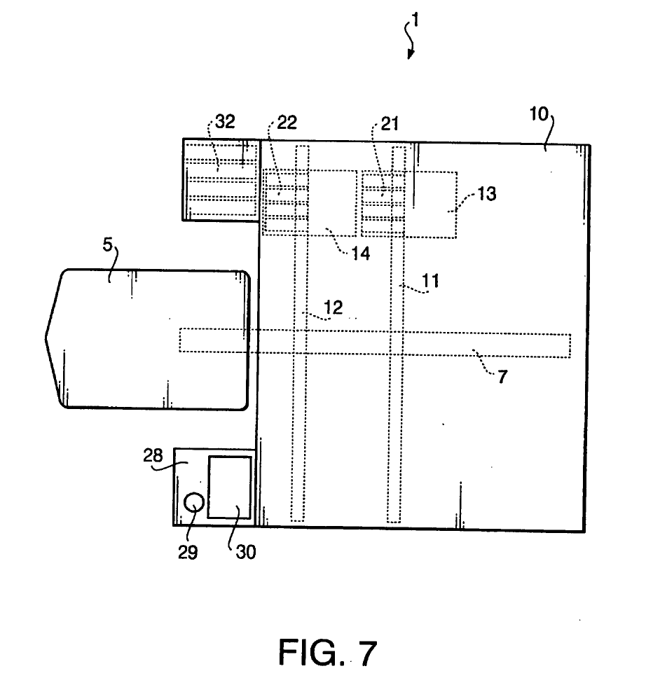

Next, the moving range of the platen 5 in the inkjet printer 1 will be described referring to FIGS. 7 to 13. Firstly, referring to FIG. 7 to FIG. 9, the moving range of the platen 5 when the first inkjet head 21 ejects the white ink and the second inkjet head 22 ejects the CMYK inks to produce an image will be described as a first embodiment.

In the first embodiment, as shown in FIG. 7, the platen 5 is completely ejected from the front side (the left-hand side in FIG. 7) of the main cover 10 in the inkjet printer 1 when the recording medium is loaded and/or unloaded to/from the platen 5. The user can load and/or unload the recording medium (for example, T-shirt, etc.) to/from the platen 5 in this state. It is noted that the above position is referred to a “loading position” hereinafter.

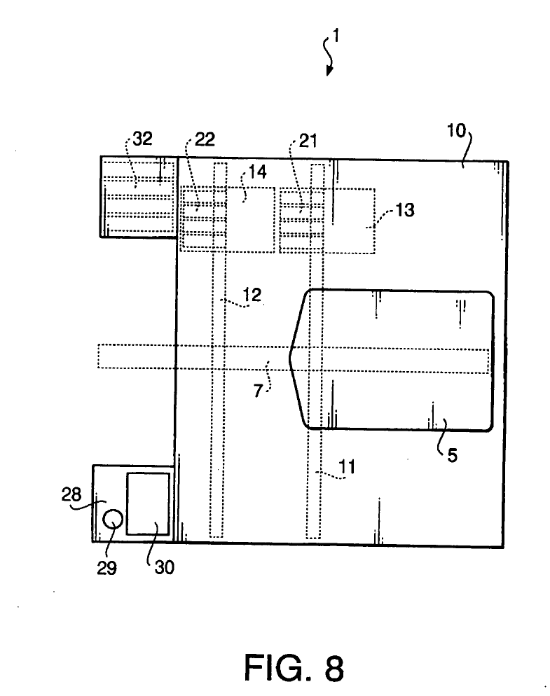

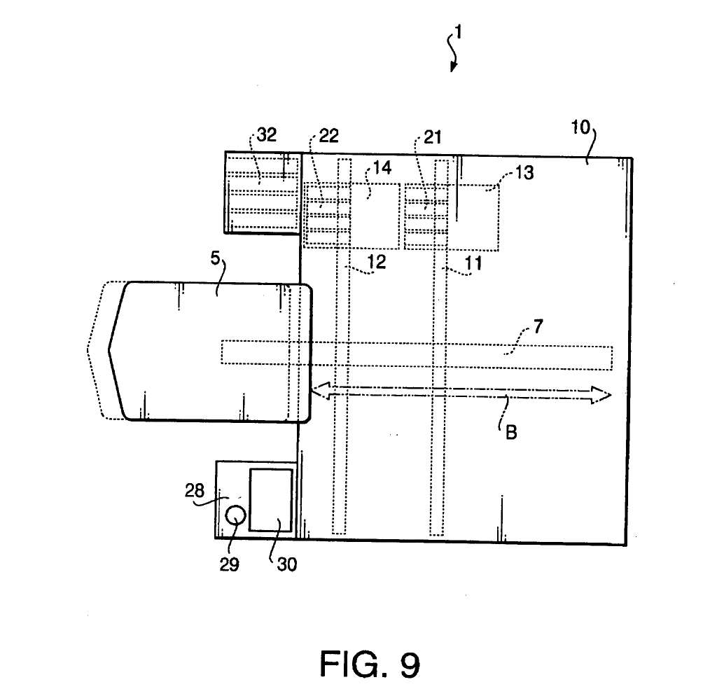

When the CPU 110 transmits a driving instruction to the stepper motor driver 147, the stepper motor 71 is driven and then the motor pulley 73 is rotated. Accordingly, the large pulley 72 and the first belt pulley 74 are rotated with the rotation of the motor pulley 73, and the timing belt 79 is driven, which causes the platen 5 to move to the rearmost side of the main cover 10 as shown FIG. 8. The position of the platen 5 in FIG. 8 will be referred to as a “print start position of the first inkjet head 21”. Then, the first inkjet head 21 is driven to eject the white ink to the recording medium on the platen 5 for printing. When the platen 5 reaches a position facing the second inkjet head 22, the second inkjet head 22 subsequently ejects the CMYK inks for printing. As the printing proceeds, the platen 5 is kept moving in a direction where it is ejected from the main cover 10 (i.e., the auxiliary scanning direction). When the printing is finished, the platen 5 has been moved to the position where only a rear part of the platen 5 is remained in the main cover 10 as shown in FIG. 9. Such a position (shown in FIG. 9) will be referred to as a “print end position”. Consequently, the moving range of the rear side edge of the platen 5 is a range indicated by an arrow B in FIG. 9, which will be referred to as “a first moving range of the platen 5”.

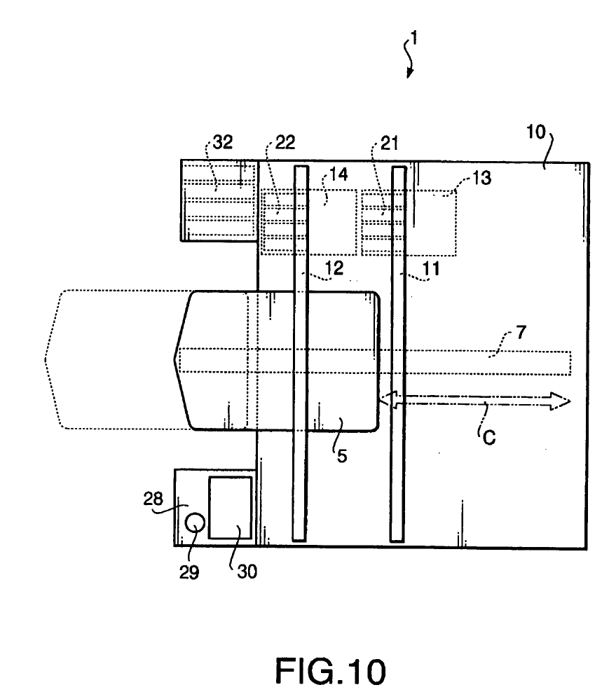

Next, referring to FIG. 7, FIG. 8 and FIG. 10, the moving range of the platen 5 when only the first inkjet head 21 is driven to eject the white ink and the second inkjet head 22 does not eject the CMYK inks will be described as a second embodiment.

In the second embodiment, firstly, the platen 5 is located to the “loading position” as in the first embodiment.

After the recording medium is loaded on the platen 5, the platen is moved to the “print start position of the first inkjet head 21” as shown in FIG. 8. Then, the first inkjet head 21 is driven to eject the white ink to the recording medium loaded on the platen 5 for printing, while the platen 5 is moved in the direction where it is ejected from the main cover 10 (i.e., the auxiliary scanning direction) as the printing proceeds. When the printing is finished, the platen 5 is stopped at the position where the rear side edge of the platen 5 is located in the vicinity of the scanning range of the first inkjet head 21 in the main cover 10 as shown in FIG. 10. Such a position of the platen 5 shown in FIG. 10 will be referred to as a “print end position of the first inkjet head 21”. In this case, the moving range of the rear side edge of the platen 5 for printing is an range indicated by an arrow C in FIG. 10, which will be referred to as “a second moving range of the platen 5”.

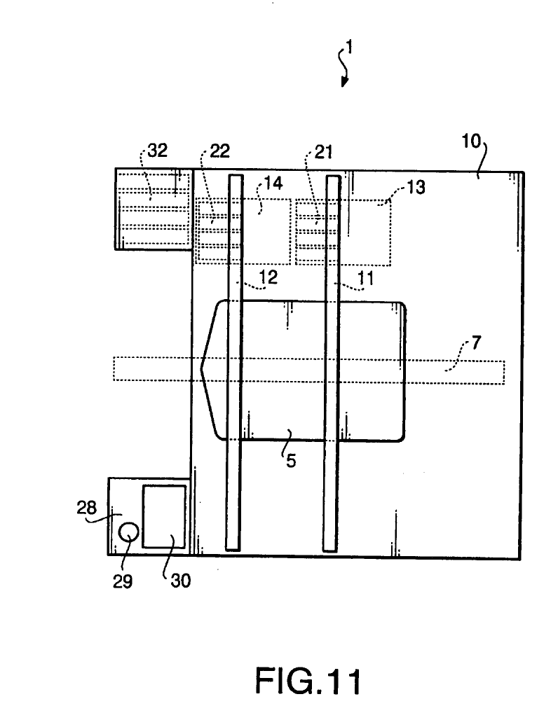

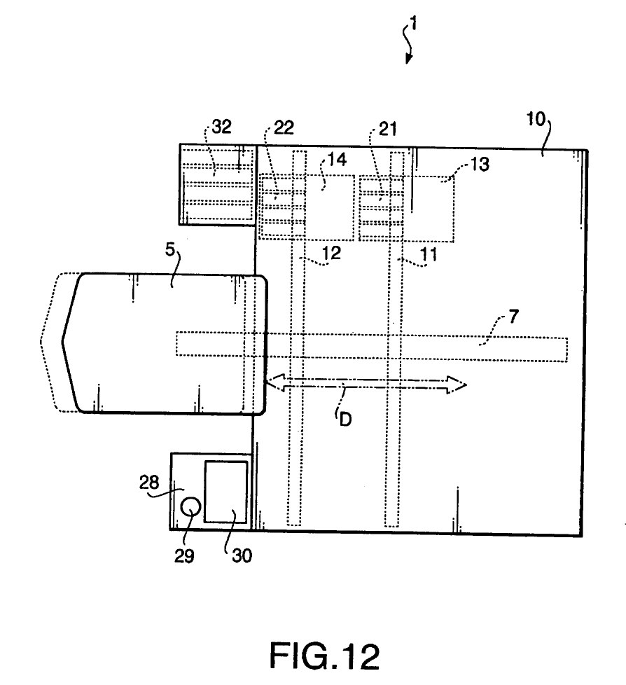

Next, referring to FIG. 7, FIG. 11 and FIG. 12, the moving range of the platen 5 in case that the first inkjet head 21 does not eject the white ink and only the second inkjet head 22 ejects the CMYK inks to produce an image will be described as a third embodiment.

In the third embodiment, initially, the platen 5 is located at the. “loading position as shown in FIG. 7.

Then, the platen 5 is moved such that the rear edge of the platen 5 is located at a position which is on the rear side with respect to a middle part (in the front-and-rear direction) of the main cover 10 as shown in FIG. 11. The position of the platen 5 in FIG. 11 will be referred to as a “print start position of the second inkjet head 22”. Since the platen 5 is moved in a direction where it is ejected from the main cover 10 as the main scanning of the second inkjet head 22 is repeated,.the printing is started from the front side of the platen 5 (i.e., the left-hand side in FIG. 11) and finished at the rear side of the platen 5 (i.e., the right-hand side in FIG. 11). Therefore, the front side of the platen 5 should face the second inkjet head 22 at the print start position of the second inkjet head 22 as shown in FIG. 11. Then, the second inkjet head 22 ejects the CMYK inks to the recording medium on the platen 5 for printing. The platen 5 is moved in a direction to be ejected from the main cover 10 (i.e., the auxiliary scanning direction) as printing proceeds. When the printing is finished, the platen 5 is stopped at the position where the rear side edge of platen 5 is located in the vicinity of the scanning range of the second inkjet head 22 as shown in FIG. 12. Such a position will be referred to a “print end position of the second inkjet head 22”. The moving range of the rear side edge of the platen 5 is a range indicated by an arrow D in FIG. 12, which will be referred to as “a third moving range of the platen 5”.

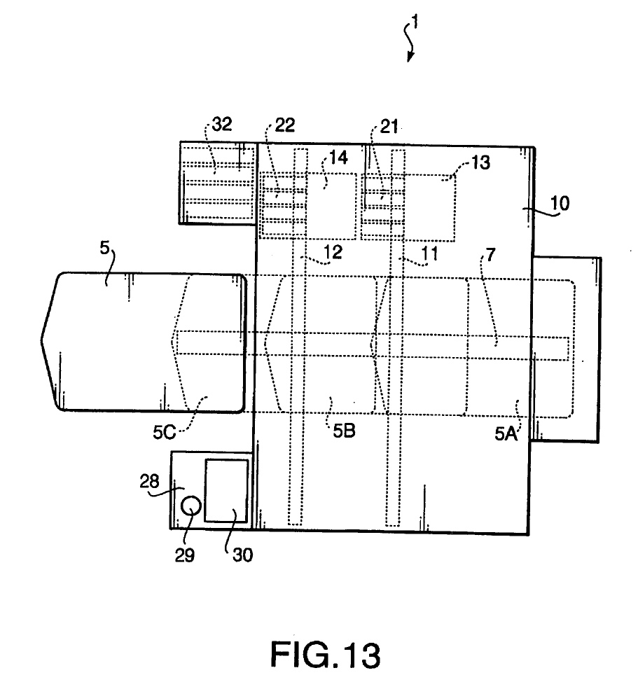

Incidentally, the inkjet printer 1 described above may be modified such that the size of main cover 10 in the auxiliary scanning direction (i.e., the front-and-rear direction) is shortened so that the platen 5 is protruded from the main cover 10 when it is located at the print start position of the first print head 21. In such a modified configuration, the main cover 10 may be formed with an opening for allowing the rear portion of the platen 5 to protrude from the main cover 10. Optionally, a second cover 10A for covering the rear end portion of the platen 5 projected from the opening formed on the rear side of the main cover 10 may be provided as shown in FIG. 13. In such configuration, the platen 5 is stopped in a position 5A (i.e., the print start position of the first print head 21) as the print start position in the first and second embodiment, and then moved to a position 5C (i.e., the print end position of the first print head) via a position 5B (i.e., the print start position of the second print head 22).

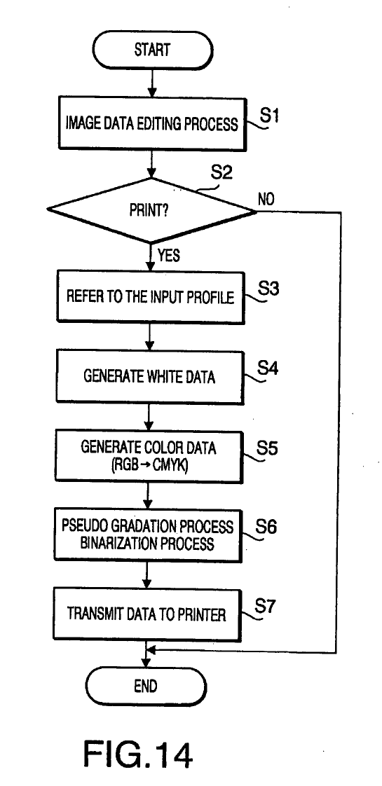

Referring to a flowchart in FIG. 14, print data generating process for generating print data will described. The process in FIG. 14 is executed by a personal computer (hereinafter referred to “PC”) which is operated by a user and connected to the inkjet printer 1 (not shown).

Firstly, an editing process for editing an image to be printed by the inkjet printer 1 is performed by the PC (S1). When a print instruction is issued after editing the image data (S2), an input profile is referred to (S3) and white data is generated (S4). The white data is generated in a same manner for generating spot color image data using an application on the PC. Next, the color data is generated (i.e., conversion from RGB data to CMYK data) (S5).

Next, a pseudo gradation process and a binarization process are applied to the generated print data (S6), and the print data is transmitted to the inkjet printer 1 (S7). Then the print data generating process is finished. Incidentally, if the judgment in S2 is NO, the print data generating process is immediately terminated.

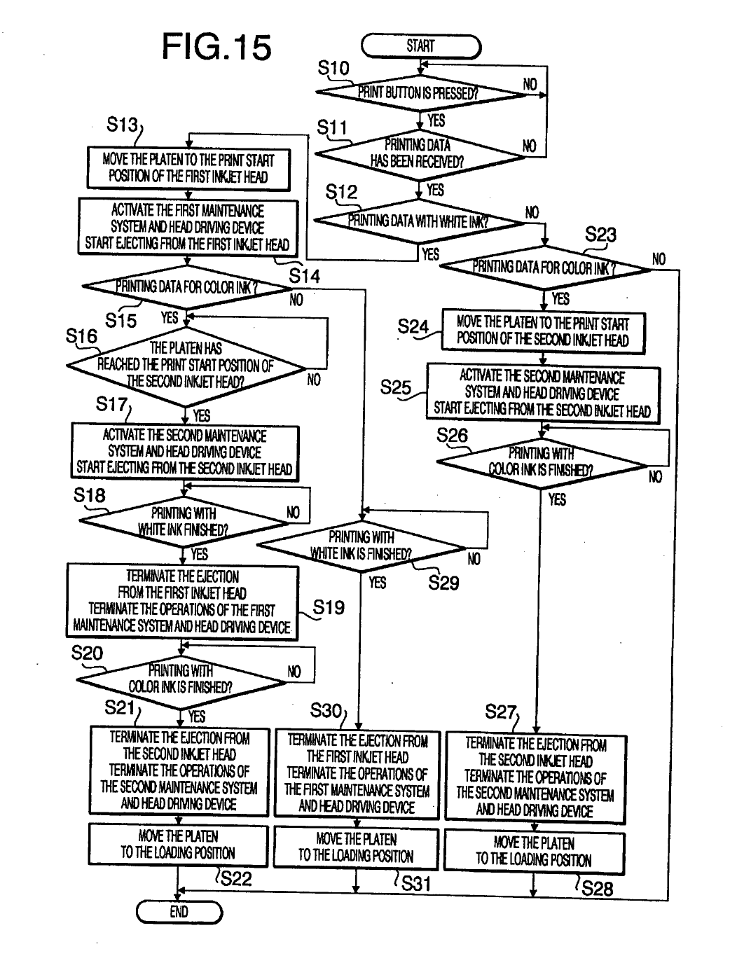

Referring now to a flowchart in FIG. 15, a printing process executed in the inkjet printer 1 will be described. The processes illustrated in the flowchart shown in FIG. 15 is stored in ROM 120 and executed by the CPU 110 of the control device 100 of the inkjet printer 1. Firstly, when the printing button 29 is pressed (S10: YES), if the print data has already been received from the PC through the USB cable or the like and stored in the RAM 130 (S11: YES), the process judges whether print data for the white ink (i.e., print data representing image to be printed by ejecting white ink through the first inkjet head 21) is included in the print data (S12). When the printing button 29 is pressed (S10: YES), if the print data has not been stored in the RAM 130 (S11: NO), the process returns to S10. If the printing button 29 has not been pressed (S10: NO), the process pauses until the printing button 29 is pressed (S10).

When the print data received from the PC and stored in the RAM 130 is the print data of the white ink (S12: YES), the platen 5 is moved to the rearmost side of the main cover 10, that is, to the print start position of the first inkjet head 21 (see FIG. 8) (S13). When the print data received from the PC and stored in the RAM 130 is not the print data for the white ink (S12: NO) but the print data for the CMYK color inks (S23: YES), the platen 5 is moved to the print start position of the second inkjet head 22 (see FIG. 12) which is a position on a lightly rear side (24).

When the platen 5 is moved to the print start position of the first inkjet head 21 (see FIG. 8) (S13), the first maintenance system for cleaning the first inkjet head 21 (not shown) and the first head driving device 140 are activated to apply a necessary maintenance to the recording head 21 such as uncapping of the first inkjet head 21, etc. Then, the printing with the white ink is started by ejecting the ink from the first inkjet head 21 (S14). When the first inkjet head 21 scanned in the main scanning direction for one line and the white ink for one line was ejected, the platen 5 is moved to an ink ejecting position of the next line in a platen ejecting direction. The printing with the white ink is performed by repeating the above operation.

When the print data received from the PC and stored in the RAM 130 includes not only the print data for the white ink but also the print data for the color (CMYK) inks (S15: YES), if the platen 5 has reached the print start position of the second inkjet head 22 (see FIG. 11) (S16: YES), the second maintenance system for cleaning the second inkjet head 22 (not shown) and the second head driving device 141 are activated to apply a necessary maintenance to the second inkjet head 22 such as uncapping thereof, etc. Then, the printing with the CMYK inks is started by ejecting the inks from the second inkjet head 22 (S17). When the second inkjet head 22 has scanned in the main scanning direction for one line and the CMYK inks for one line have been ejected, the platen 5 is moved toward the platen ejecting direction so that a position of the platen corresponding to the next line is located at the ink ejecting position of the second inkjet head 22. The printing with the CMYK inks is performed by repeating the above operation. It is noted that in the above case, since the platen 5 positioned such that each line (in the main scanning direction) can face both the first inkjet head 21 and the second inkjet head 22, the ejection of ink is performed from either of the first inkjet head 21 and the second inkjet head 22.

When the printing of the print data with the white ink is finished (S18: YES), the ejection of the white ink from the first inkjet head 21 is finished, and the operation of the first head driving device 140 and the first maintenance system are finished (S19). Thus, the first inkjet head 21 mounted on the carriage 13 is moved to the position of the first maintenance system and the necessary maintenance such as wiping of a nozzle of the first inkjet head 21 and capping, is performed. Thereafter, the first inkjet head 21 stays in the standby state.

When the printing of the print data with the color inks is finished (S20: YES), the ejection of the color inks from the second inkjet head 22 is finished, and the operation of the second head driving device 141 and the second maintenance system are finished (S21.) Thereafter, the second inkjet head 22 mounted on the carriage 14 is moved to the position of the second maintenance system and the necessary maintenance such as wiping of a nozzle of the second inkjet head 22 and capping is performed. Thereafter, the second inkjet head 22 stays in the standby state.

After that, the platen 5 is moved to the loading position (i.e., the platen 5 is ejected from the main cover 10 as shown in FIG. 7) (S22) and the process is finished.

If the print data received from the PC and stored in the RAM 130 does not include the print data with the color (CMYK) inks (i.e., the print data includes only the print data for the white ink) (S15: NO), when the printing of the print data with the white ink is finished (S29: YES), the ejection of the white ink from the first inkjet head 21 is finished, and the operation of the first head driving device 140 and the first maintenance system are finished (S30.) Thereafter, the first inkjet head 21 mounted on the carriage 13 is moved to the position of the first maintenance system and the necessary maintenance such as wiping of a nozzle of the first inkjet head 21 and capping is performed. Then, the first inkjet head 21 stays in the standby state. Thereafter, the platen 5 is moved to the loading position (i.e., ejected from the main cover 10 as shown in FIG. 7) (S31) and the process is finished.

When the print data received from the PC and stored in the RAM 130 does not include the print data for the white ink (S12: NO) but includes the print data for the color (CMYK) inks (S23: YES), the platen 5 is moved to the print start position of the second inkjet head 22 (see FIG. 11) (S24.)

Then, the second maintenance system for cleaning the second inkjet head 22 (not shown) and the second head driving device 141 are activated to perform a necessary maintenance such as uncapping of the second inkjet head 22, etc. Then, the printing with the CMYK inks is started by ejecting the CMYK inks from the second inkjet head 22 (S25). When the second inkjet head 22 has scanned in the main scanning direction by one line and the CMYK ink for one line have been ejected, the platen 5 is moved to the ink ejecting position of the next line in the platen ejecting direction.

When the printing of the print data with the color ink is finished (S26: YES), the ejection of the color inks from the second inkjet head 22 is finished, and the operation of the second head driving device 141 and the second maintenance system are finished (S27). Thereafter, the second inkjet head 22 mounted on the carriage 14 is moved to the position of the second maintenance system and the necessary maintenance such as wiping of a nozzle of the second inkjet head 22 and capping are performed. Then, the second inkjet head 22 stays in the standby state. Thereafter, the platen 5 is moved to the loading position (i.e., ejected from the main cover 10 as shown in FIG. 7) (S28) and the process is terminated.

According to the above, in the inkjet printer 1, if the print data if only for the white ink, after finishing the printing with the white ink, the platen 5 is moved directly to the loading position, and the first inkjet head 21 is moved to the position of the first maintenance system to have a necessary maintenance to the recording head (e.g., wiping a nozzle surface and capping) and then, the first inkjet head 21 stays in the standby state. Similarly, if the print data is only for the color inks (CMYK) (i.e., the print data for the white ink is not included), after finishing the printing operation, the platen 5 is moved to the loading position, and the second inkjet head 22 is moved to the position of the second maintenance system to have a necessary maintenance (e.g., wiping a nozzle surface and capping) and then, the second inkjet head 22 stays in the standby state.

If the print data includes data for both the white ink and the color ink, the first maintenance system and the first head driving device 140 are activated to perform a necessary maintenance, and then, the white ink is ejected from the first inkjet head 21. Then, the second maintenance system and the second head driving device 140 are activated to perform a necessary maintenance such as uncapping, etc. and then, the color ink is ejected from the second inkjet head 22. The timing of ejecting the color inks from the second inkjet head 22 after ejecting the white ink from the first inkjet head 21 is determined depending on conditions of the first inkjet head 21 (e.g., resolution or driving voltage, etc.). Then, the first inkjet head 21 and the second inkjet head 22 eject necessary ink in accordance with the print data with the white ink and the color ink, as the process drives the first head driving device 140 and the second head driving device 141. When the print data is finished, each inkjet head stops ejecting the ink. Thereafter, the first inkjet head 21 and second inkjet head 22 is moved to the first maintenance system and the second maintenance system, respectively, and then, stay in the standby state for preparing the next printing, with protecting the surface of the head, which is not used, by capping for preventing the unused head from drying and attachment of foreign substances.

As described above, since the inkjet printer 1 includes two inkjet heads arranged in parallel with each other, when the white ink is ejected to a recording medium with a deep colored background firstly and then the color ink is ejected thereto, or when the color ink is ejected on a recording medium with white or light colored background, the recording medium is moved only once to the print start position and further moved once from the print end position to the loading position regardless of combinations of inkjet heads to be used. Accordingly, the period of time necessary for printing can be reduced. Further, the period of time for printing can also be reduced since the moving range is optimized according to whether the color of inks are to be used. Additionally, the surface of the inkjet head which is not used is always protected by capping for preventing drying and attachment of foreign substances.

Additionally, when the amounts of print data are different largely between two inkjet heads arranged and scanning in parallel, only the inkjet head necessary for the printing is driven. Therefore, a driving time of each carriage loading each inkjet head can be optimized comparing with a case where multiple heads are arranged in one line. Therefore, the printing time period can be well reduced. For example, when the print data or amount of ejection with the color ink of the second inkjet head 22 is smaller than that of the first inkjet head 21, the driving of the second inkjet head 22 is finished at the approximately same time when the printing with the first inkjet head 21 is finished or prior thereto. Accordingly, the ejection time period of the white ink and the color ink can be optimized.

When the print data of the second inkjet head 22 is larger than that of the first inkjet head 21, or the amount of the ejection of the ink corresponding to the white data is relatively small, the second inkjet head 22 might start to eject the ink before the first inkjet head 21 does. In this case, the driving of the first inkjet head 21 and the second inkjet head 22 are optimized, thereby optimizing the ejection time with the white ink and the color ink.

The present invention is not to be restricted by the above particular illustrative embodiments and various modifications can be made. For example, the platen does not need to be covered by a housing (the main cover 10). That is, the housing may be configured to have a separate part which can be detached from the rear side of the housing. With such a configuration, the separate part can be detached when the first inkjet head 21 is used so that the platen can protrude from the housing. With the above configuration, the housing may be configured to be thinner. When the amount of print data size is different largely between the white ink and the color ink, uncapping of each inkjet head may be delayed as late as possible to protect each inkjet head. For example, the uncapping of the second inkjet head may be performed before the uncapping of the first inkjet head depending on the print data (image data). Therefore the printing time period may be further reduced.

Further, the platen 5 may not be moved back to the print start position of the first inkjet head when the start position of the print data with the white ink is on the upstream side in the moving direction of the platen 5 for printing of the print data for the color inks. Therefore, the printing time can be further reduced.

A number of the inkjet heads scanning in parallel (i.e., arranged in parallel) are not limited to two, but may be three, four, or more. Additionally, the recording head is not limited to the inkjet head but the invention may be applicable to the heads which are arranged in parallel in the platen-moving direction and are driven serially in the main scanning direction with respect to the recording medium on the platens

It should be noted that the present invention is applicable to a printing apparatus having a plurality of recording heads arranged parallelly along the platen-moving direction and configured to scan parallelly to eject the ink one the recording medium held by the platen.

What is claimed is:

1. A printing apparatus, comprising:
a medium supporting unit having a supporting surface configured to support a recording medium;
a first recording head configured to eject ink in accordance with print data;
a second recording head configured to eject ink in accordance with the print data;
a recording head control device configured to control the first recording head and the second recording head;
a first head moving device configured to move the first recording head, in a main scanning direction, relatively to the medium supporting unit;
a second head moving device configured to move the second recording head, in the main scanning direction, relatively to the medium supporting unit;
a head movement control device configured to control the first head moving device and the second head moving device;
a medium supporting unit moving device configured to move the medium supporting unit, and
a medium movement control device configured to control the medium supporting unit moving device to move the medium supporting unit such that a moving range of the medium supporting unit is differentiated depending on whether the ink is ejected from both the first recording head and the second recording head, only from the first recording head or only from the second recording head.

2. The printing apparatus according to claim 1,
wherein, when the ink is ejected from both the first recording head and the second recording head, the medium supporting unit is moved within a first moving range of the medium supporting unit in an auxiliary scanning direction which is perpendicular to the main scanning direction, the first moving range of the medium supporting unit being a moving range relative to the first head moving device and the second head moving device,
wherein, when the ink is ejected only from the first recording head, the medium supporting unit is moved within a second moving range of the medium supporting unit in the auxiliary scanning direction, the second moving range of the medium supporting unit being a moving range relative to the first head moving device, and
wherein, when the ink is ejected only from the second recording head, the medium supporting unit is moved within a third moving range of the medium supporting unit in the auxiliary scanning direction, the third moving range of the medium supporting unit being a moving range relative to the second head moving device, and
the first moving range, second moving range and third moving range being different from each other.

3. The printing apparatus according to claim 1,
wherein the head movement control device operates such that the first head moving device moves the first recording head, while the second head moving device does not move the second recording head, when the ink is to be ejected only from the first recording head onto the recording medium.

4. The printing apparatus according to claim 1,
wherein the head movement control device operates such that the second head moving device moves the second recording head, while the first head moving device does not move the first recording head, when the ink is ejected only from the second recording head onto the recording medium.

5. The printing apparatus according to claim 1,
wherein, when the medium supporting unit is moved within the first moving range, the head movement control device controls the second head moving device to start moving the second recording head after the medium supporting unit has passed through a predetermined position.

6. The printing apparatus according to claim 1,
wherein, when the medium supporting unit is moved within the first moving range, the head movement control device controls the first head moving device to stop moving the first recording head at a time when the first recording head has finished ejecting the ink in accordance with the print data.

7. The printing apparatus according to claim 1, wherein the ink ejected from the first recording head is white ink.

8. The printing apparatus according to claim 7, wherein the ink ejected from the second recording head is non-white ink.

9. A method of controlling a printing apparatus which is provided with a medium supporting unit configured to support a recording medium, a first recording head configured to eject ink in accordance with print data, a second recording head configured to eject ink in accordance with the print data, the method comprising the steps of:
moving the medium supporting unit is moved within a first moving range in an auxiliary scanning direction which is perpendicular to the main scanning direction when the ink is ejected from both the first recording head and the second recording head, the first moving range of the medium supporting unit being a moving range relative to the first head moving device and the second head moving device,
moving the medium supporting unit within a second moving range in the auxiliary scanning direction when the ink is ejected only from the first recording head, the second moving range of the medium supporting unit being a moving range relative to the first head moving device, and
moving the medium supporting unit within a third moving range in the auxiliary scanning direction when the ink is ejected only from the second recording head, the third moving range of the medium supporting unit being a moving range relative to the second head moving device,
the first moving range, second moving range and third moving range being different from each other.

10. The method according to claim 9,
wherein, when the medium supporting unit is moved within the first moving range, the step of moving the second recording head starts moving the second recording head after the medium supporting unit has passed through a predetermined position.

11. The method according to claim 9,
wherein, when the medium supporting unit is moved within the first moving range, the step of moving the first recording head finishes moving the first recording head at a time when the first recording head has finished ejecting the ink in accordance with the print data.

12. A recoding medium storing a computer program which causes a computer, when executed thereby, to control a printing apparatus which is provided with a medium supporting unit configured to support a recording medium, a first recording head configured to eject ink in accordance with print data, a second recording head configured to eject ink in accordance with the print data, the program including the instructions to:
move the medium supporting unit is moved within a first moving range in an auxiliary scanning direction which is perpendicular to the main scanning direction when the ink is ejected from both the first recording head and the second recording head, the first moving range of the medium supporting unit being a moving range relative to the first head moving device and the second head moving device,
move the medium supporting unit within a second moving range in the auxiliary scanning direction when the ink is ejected only from the first recording head, the second moving range of the medium supporting unit being a moving range relative to the first head moving device, and
move the medium supporting unit within a third moving range in the auxiliary scanning direction when the ink is ejected only from the second recording head, the third moving range of the medium supporting unit being a moving range relative to the second head moving device,
the first moving range, second moving range and third moving range being different from each other.
